(19) United States
(12) Patent Application Publication
(10) Pub. No.: US 2010/0271287 A1
(43) Pub. Date: Oct. 28, 2010

(54) Dual-display transportable media cart

(76) Inventors: Christopher Bourne, Stans Bury Park, UT (US); William Deberard, Brighton, CO (US); Darrin Thurston, Splt Lake City, UT (US)

Correspondence Address: EVERETT D. ROBINSON;Echelon IP, LLC, P.O. Box 1047, American Fork, UT, 84003-1047, US

(21) Appl. No.: 12/766,885

(22) Filed: Apr. 24, 2010

Related U.S. Application Data
(60) Provisional application No. 61/172,421, filed on Apr. 24, 2009.

(51) Int. Cl. G09G 5/00; A47B 81/00

(52) U.S. Cl. 345/1.3; 312/249.1; 248/274.1; 248/299.1

(57) ABSTRACT

The claimed systems relate generally to a cart having repositionable displays, and more particularly to a mobile cart having a frame on which is affixed two or more fixtures having a display mount, the fixtures providing for the movement of displays affixed thereto in a position for viewing, and another position for cart movement, such as movement between rooms through a doorway or an elevator. Also disclosed are particular articulating arms for such fixtures, mounted to one or more posts, some having one or more pivotable arms allowing for repositioning of displays relative to a cart. Detailed information on various example embodiments of the inventions are provided in the Detailed Description below, and the inventions are defined by the appended claims.

### CROSS REFERENCE TO RELATED APPLICATIONS

This Application claims the benefit of U.S. Provisional Application No. 61/172,421 filed on Apr. 24, 2009 both of which are hereby incorporated by reference, each in its entirety.

### BACKGROUND

Displays have been used for many purposes, including the presentation of video, the display of computer graphical user interfaces, and distant parties to a videoconference. Many if not most of these displays are mounted in a permanent position, that position having been selected for the purpose for which the display will be used. Thus, a display for a computer is located near a computer, and a display for a teleconference might be located in a conference room. These displays are left in place, requiring the relocation of people to the display where an associated function is to occur.

Some displays, however, have been located to a portable cart. In such applications, the display is typically quite small to make the cart and the equipment it carries portable. For example, it is known to carry a computer and a display on a cart, wheeling the cart to a location where it is needed. In another example, it is known to mount an oscilloscope or other diagnostic equipment on a cart for transportation to electronics or machinery to be analyzed. In both cases, the display is selected to be small so as not to interfere with the movement of the cart through passageways and between objects. Thus, existing displays tend to be either fixed in location, or moveable and small enough to be placed on a cart.

### BRIEF SUMMARY

The claimed systems relate generally to a cart having repositionable displays, and more particularly to a mobile cart having a frame on which is affixed two or more fixtures having a display mount, the fixtures providing for the movement of displays affixed thereto in a position for viewing, and another position for cart movement, such as movement between rooms through a doorway or an elevator. Also disclosed are particular articulating arms for such fixtures, mounted to one or more posts, some having one or more pivotable arms allowing for repositioning of displays relative to a cart. Detailed information on various example embodiments of the inventions are provided in the Detailed Description below, and the inventions are defined by the appended claims.

### BRIEF DESCRIPTION OF THE DRAWINGS

FIG. 1 shows the front of a fully-expanded first exemplary display fixture arrangement in perspective.

FIG. 2 shows the rear of a fully-expanded first exemplary display fixture arrangement in perspective.

FIG. 3 shows a fully-expanded first exemplary display fixture arrangement from the top.

FIG. 4 shows a partially-expanded first exemplary display fixture arrangement from the top.

FIG. 5 shows a more partially-expanded first exemplary display fixture arrangement from the top.

FIG. 6 shows a collapsed first exemplary display fixture arrangement from the top.

FIG. 7 shows a fully-expanded first exemplary display fixture arrangement from the top, adjusted for viewing at an angle.

FIG. 8 shows a fully-expanded second exemplary display fixture arrangement having one post rather than two.

FIG. 9 shows the second exemplary display fixture arrangement, fully expanded, from the top.

FIG. 10 shows the second exemplary display fixture arrangement, fully expanded and adjusted for viewing angle, from the top.

FIG. 11 shows the second exemplary display fixture arrangement, partially collapsed, from the top.

FIG. 12 shows the second exemplary display fixture arrangement, more partially collapsed, from the top.

FIG. 13 shows the second exemplary display fixture arrangement, fully collapsed, from the top.

FIG. 14 shows a first exemplary cart system in a dual-display static configuration.

FIG. 15 shows the components of the first exemplary cart system in a single-display static configuration.

FIG. 16 shows the components of the first exemplary cart system in a dual-display static configuration.

FIG. 17 shows the attachment of a vertical support member in the first exemplary cart system in a single-display static configuration.

FIG. 18 shows the attachment of a static mount in the first exemplary cart system in a single-display static configuration.

FIG. 19 shows the attachment of a mounting bracket in the first exemplary cart system in a single-display static configuration.

FIG. 20 shows the attachment of a mounting bracket to a static mount in the first exemplary cart system in a single-display static configuration.

FIG. 21 shows the fully-assembled first exemplary cart system in a single-display static configuration.

FIG. 22 shows the attachment of a vertical support member in the first exemplary cart system in a dual-display static configuration.

FIG. 23 shows the attachment of a horizontal support in the first exemplary cart system in a dual-display static configuration.

FIG. 24 shows the attachment of a camera shelf in the first exemplary cart system in a dual-display static configuration.

FIG. 25 shows the attachment of two static mounts in the first exemplary cart system in a dual-display static configuration.

FIG. 26 shows the attachment of a codec shelf in the first exemplary cart system in a single-display static configuration.

FIG. 27 shows the attachment of a codec shelf in the first exemplary cart system in a dual-display static configuration.

FIG. 28 shows the front of a fully-expanded third exemplary display fixture arrangement in perspective.

FIG. 29 shows a universal bracket of the third exemplary display fixture.

FIG. 30 shows a mounting bracket of the third exemplary display fixture.

FIG. 31 shows a universal bracket having mountings for several sizes of displays in the third exemplary display fixture.

FIG. 32 shows the front of a fully-expanded third exemplary display fixture arrangement in perspective.

FIG. 33 shows an upper ratcheting lever in the third exemplary display fixture arrangement.

FIG. 34 shows a lower-locking pin in the third exemplary display fixture arrangement.

FIG. 35 shows the front of a fully-collapsed third exemplary display fixture arrangement in perspective.

FIG. 36 shows the components of a fourth exemplary cart for a one-display configuration.

FIG. 37 shows the components of a fourth exemplary cart for a two-display configuration.

FIG. 38 shows the attachment of a vertical support in the fourth exemplary cart for a one-display configuration.

FIG. 39 shows the attachment of a static mount in the fourth exemplary cart for a one-display configuration.

FIG. 40 shows the attachment of a mounting bracket to a display in the fourth exemplary cart.

FIG. 41 shows the attachment of a mounting bracket to a static mount in the fourth exemplary cart for a one-display configuration.

FIG. 42 an assembled fourth exemplary cart in a one-display configuration.

FIG. 43 shows the attachment of a vertical support in the fourth exemplary cart for a two-display configuration.

FIG. 44 shows the attachment of a horizontal support in the fourth exemplary cart for a two-display configuration.

FIG. 45 shows the attachment of a camera shelf in the fourth exemplary cart for a two-display configuration.

FIG. 46 shows the attachment of a static mounts in the fourth exemplary cart for a two-display configuration.

FIG. 47 shows the attachment of a mounting bracket to a display in the fourth exemplary cart.

FIG. 48 shows the attachment of a mounting brackets to static mounts in the fourth exemplary cart for a two-display configuration.

FIG. 49 an assembled fourth exemplary cart in a two-display configuration.

FIG. 50 shows the attachment of a camera to a camera shelf in the fourth exemplary cart for a two-display configuration.

FIG. 51 shows the attachment of a codec shelf in the fourth exemplary cart for a one-display configuration.

FIG. 52 shows the attachment of a codec shelf in the fourth exemplary cart for a two-display configuration.

FIG. 53 shows the fourth exemplary cart in a two-display configuration with an articulating fixture in perspective from the front.

FIG. 54 shows the fourth exemplary cart in a two-display configuration with an articulating fixture in perspective from the rear.

FIG. 55 shows the fourth exemplary cart in a two-display configuration with an articulating fixture from the top.

FIG. 56 shows the fourth exemplary cart in a two-display configuration with an articulating fixture in perspective, one display removed.

FIG. 57 shows the fourth exemplary cart in a two-display configuration with an articulating fixture from the front, one display removed.

FIG. 58 shows the fourth exemplary cart in a two-display configuration with an articulating fixture from the side.

Reference will now be made in detail to particular implementations of the various inventions described herein in their various aspects, examples of which are illustrated in the accompanying drawings and in the detailed description below.

### DETAILED DESCRIPTION

The text below will refer to several exemplary products, which serve to introduce the concepts relative to the claimed inventions, however it is to be understood that these examples are presented for communicative reasons, and do not limit the claimed inventions in any way.

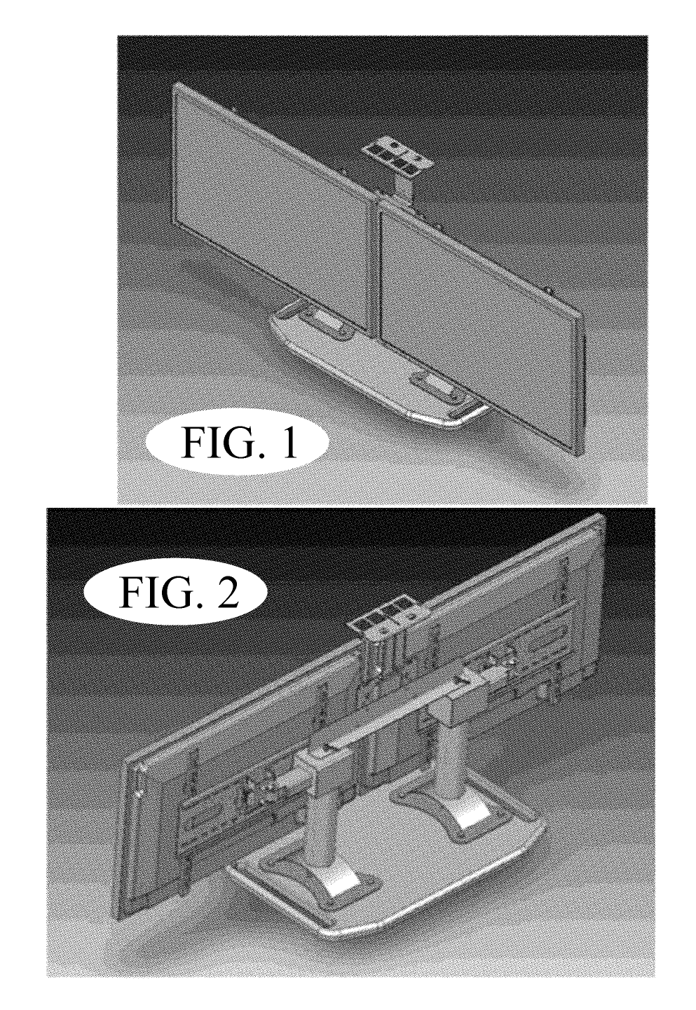

FIGS. 1 and 2 show from the front and back, respectively, a first exemplary fixture arrangement having two posts in a fully-expanded configuration, the fixture being attached to an ordinary cart tabletop. From these views it can be seen that the display combination is much wider than the tabletop itself, permitting a much wider field of view than would otherwise be allowable if one display were used as wide as the tabletop. In this example, the displays are plasma monitors, which carry substantial weight for which the fixtures are designed to support.

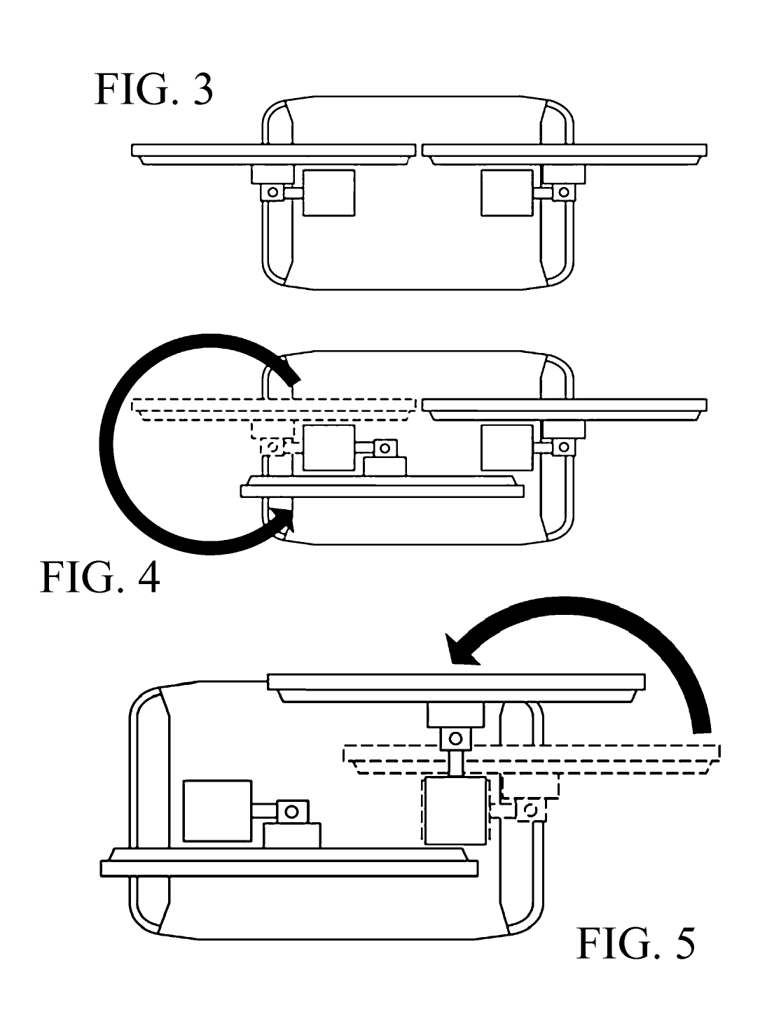

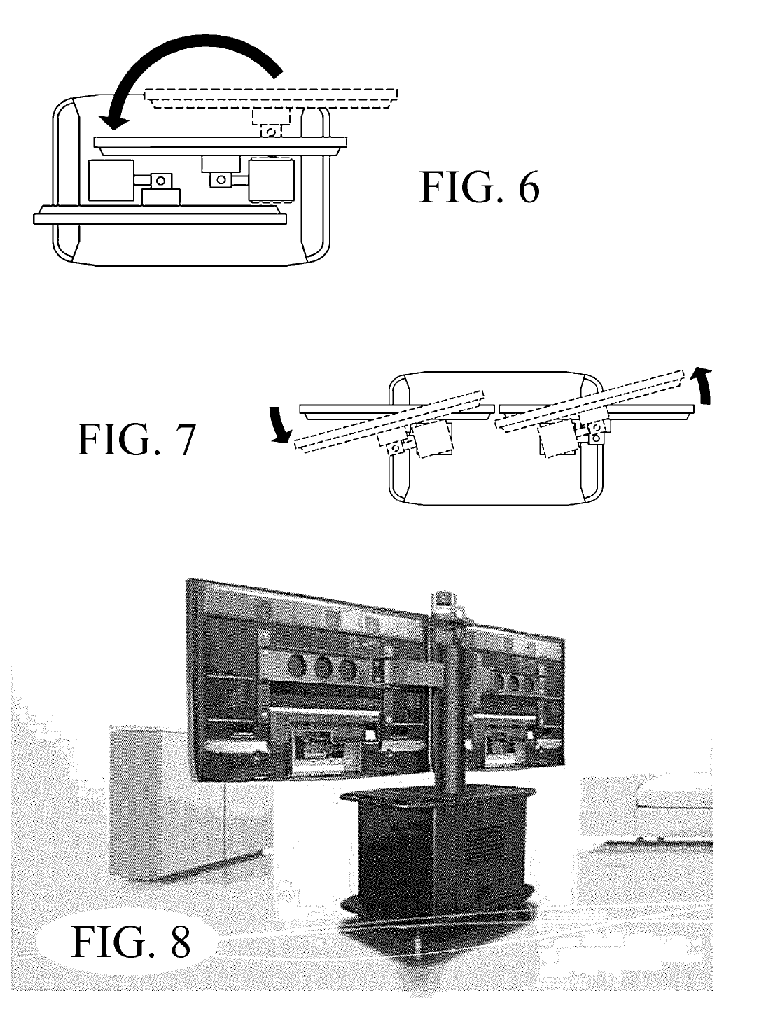

This fixture arrangement is capable of being collapsed to a much smaller configuration. As seen from the top in FIG. 3, the pair of displays are nearly twice the width of the tabletop. A first step in collapsing the arrangement is to rotate on of the displays 180 degrees on its post to be rearward-facing, as shown in FIG. 4. The other display is then relocated by rotating the other arm on its post 180 degrees, but while maintaining a forward-facing orientation, as shown in FIG. 5. As seen in FIG. 6, the fixture arrangement in a fully-collapsed state falls nearly within the space above the tabletop, providing for a less-obtrusive arrangement that, like the other examples described herein, can be moved through doorways and into elevators with much less effort.

In this example each monitor is mounted to a swing arm fixture arrangement with two pivot points. These pivot points are located near or on the joint between the post and the arm and near the point of the display to the arm. If desired, the arrangement may provide for locking of the displays into position, for example with the bar shown in FIG. 2. Also in this example, each display is independently rotatable as shown in FIG. 7, allowing for directional adjustments for the viewing convenience of any forward participants, without having to move the tabletop itself and/or any cart to which it might be attached.

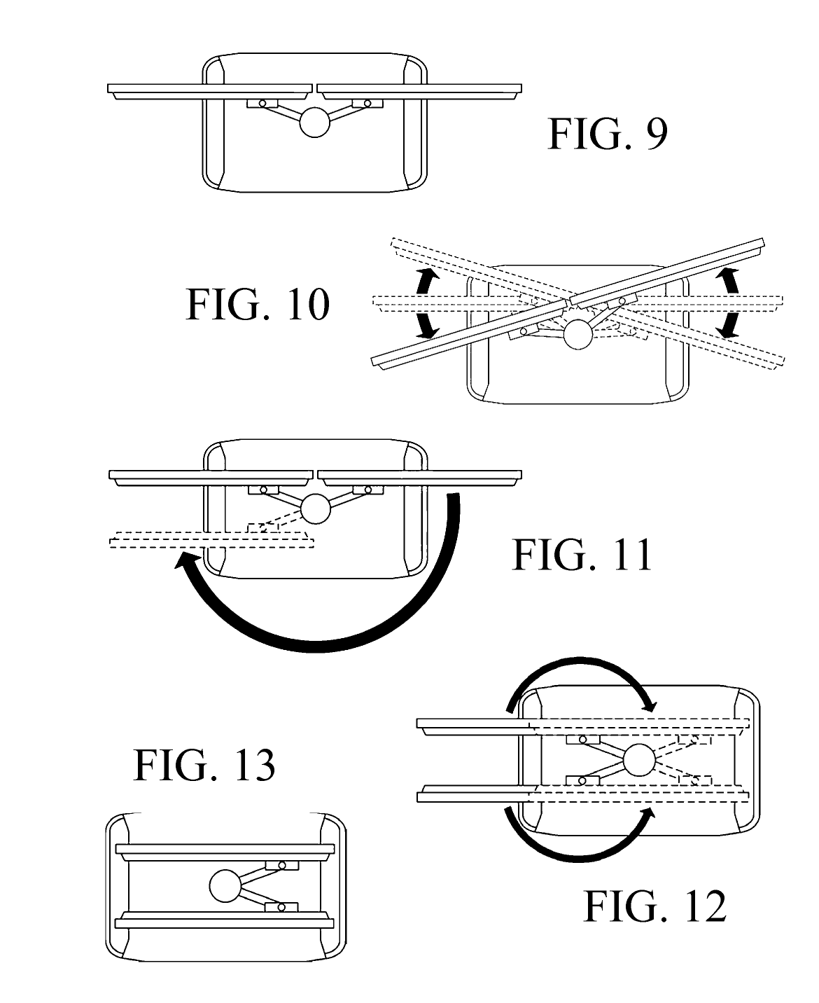

However, a fixture arrangement may also take a one-post configuration, as seen in the second exemplary fixture arrangement of FIG. 8, here shown attached to a rolling cart. As can be seen from the top in FIG. 9, each display is mounted on an articulating arm, each arm having two pivot points. The arm of this design is longer than the first exemplary arrangement, permitting both a compact collapsed arrangement and the arrangement shown having side-by-side displays in a full-expanded configuration. This arrangement also allows for viewing adjustments by rotating both displays around the post, as seen in FIG. 10.

To collapse the arrangement, one display is rotated about the post to be reverse-facing, as shown in FIG. 11. Both displays are then moved to the center of the cart using both pivots in each set, as shown in FIG. 12, arriving at the fully-collapsed configuration shown in FIG. 13 with the displays substantially centered above the cart.

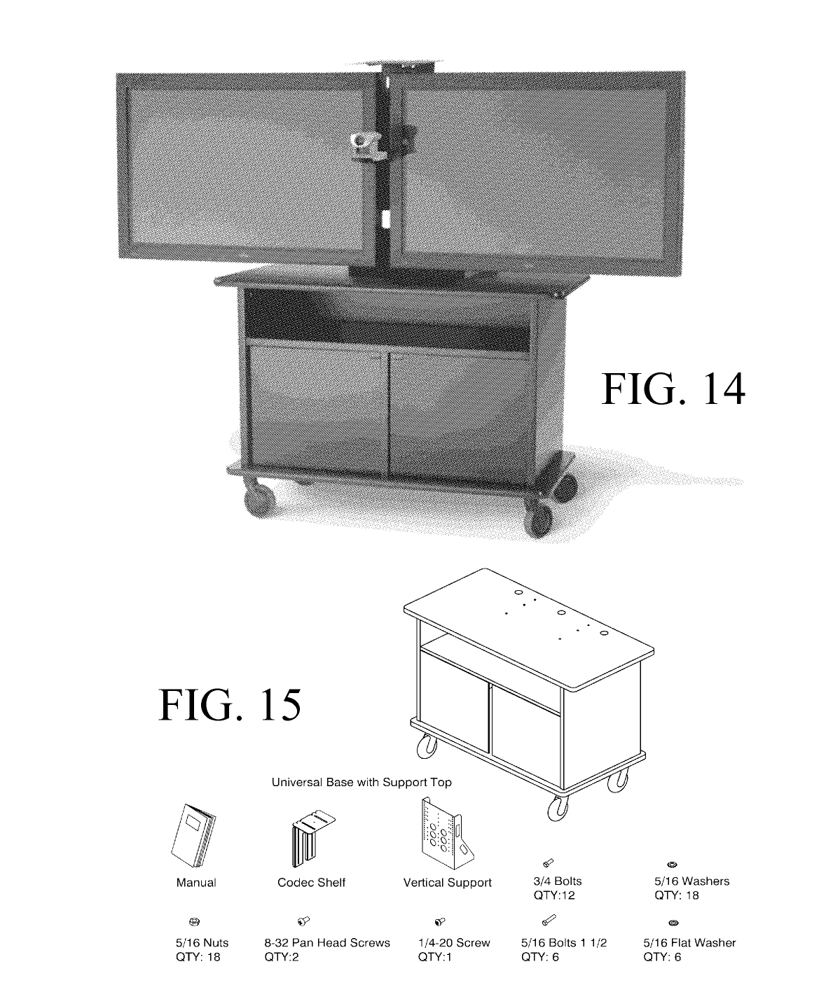

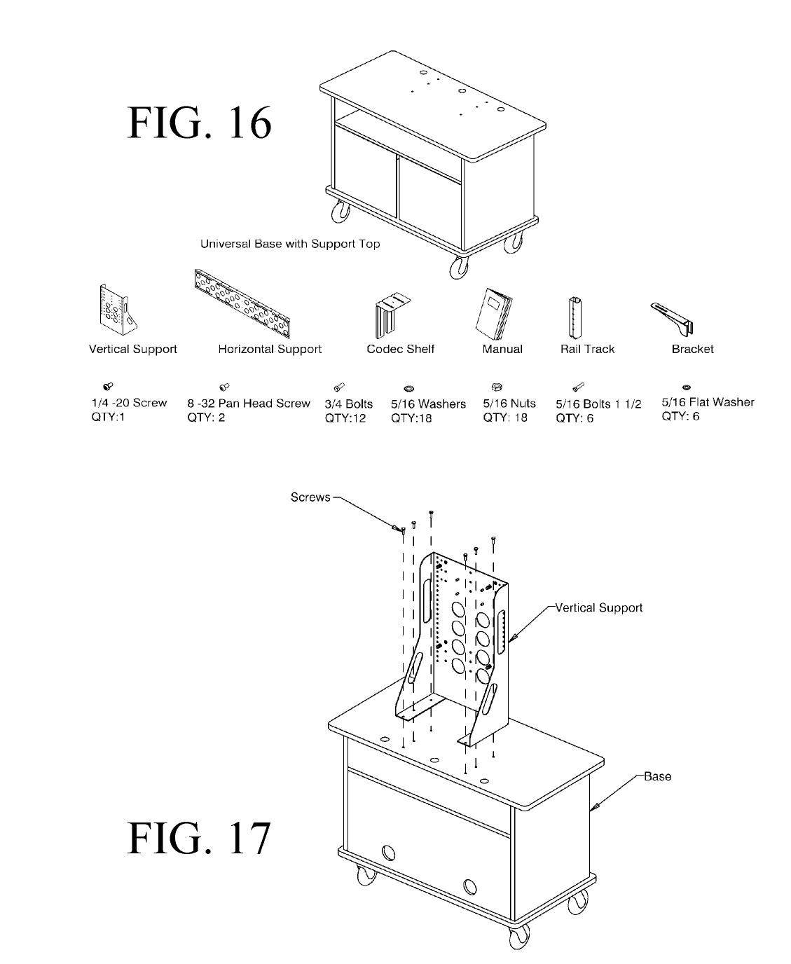

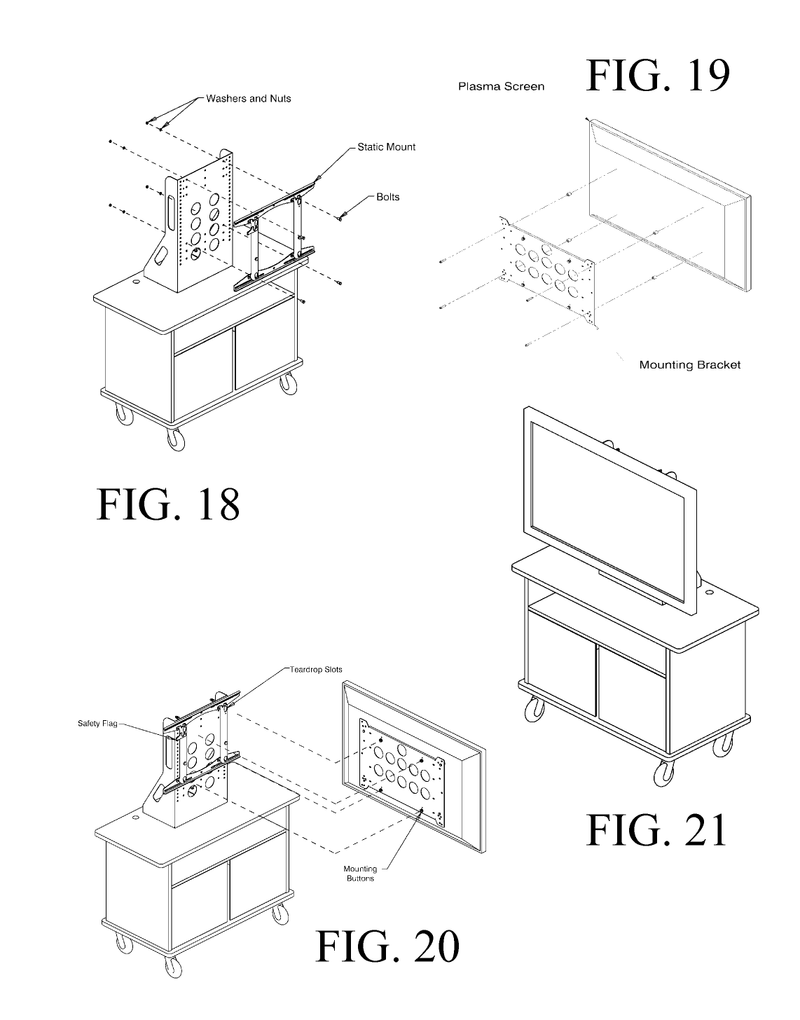

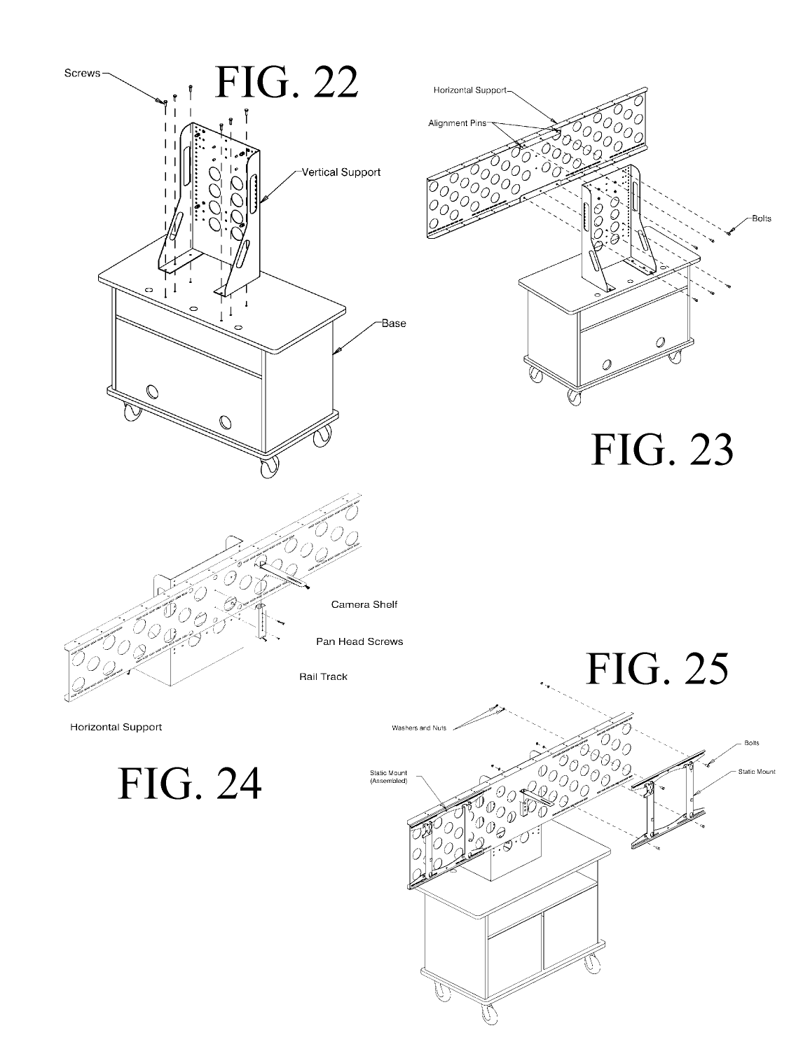

Although the examples above show expanding and collapsible display fixture arrangements, a cart can be supplied that provides this and/or alternately a static arrangement. FIG. 14 shows one such cart configurable in that way. For configuration with a single display, the parts shown in FIG. 15 are used. For configuration with a static dual-display, the parts shown in FIG. 16 are used. Assembly of the single-display configuration proceeds with attachment of a vertical support as in FIG. 17, a static mount as in FIG. 18, a mounting bracket to the display as in FIG. 19, and attachment of the mounting bracket to the mount as in FIG. 20, arriving at the arrangement shown in FIG. 21. Similarly, assembly of the static dual-display configuration proceeds with attachment of a vertical support as in FIG. 22, a horizontal support and camera shelf as in FIGS. 23 and 24, two static mounts as in FIG. 25, mounting bracket to the displays and attachment of corresponding mounting brackets to the static mounts. Note that the vertical support may be common between the one- and two-display configurations. Also note that the tabletop may also provide for the mounting of posts as described above, permitting for an expanding and collapsing display configuration as described above.

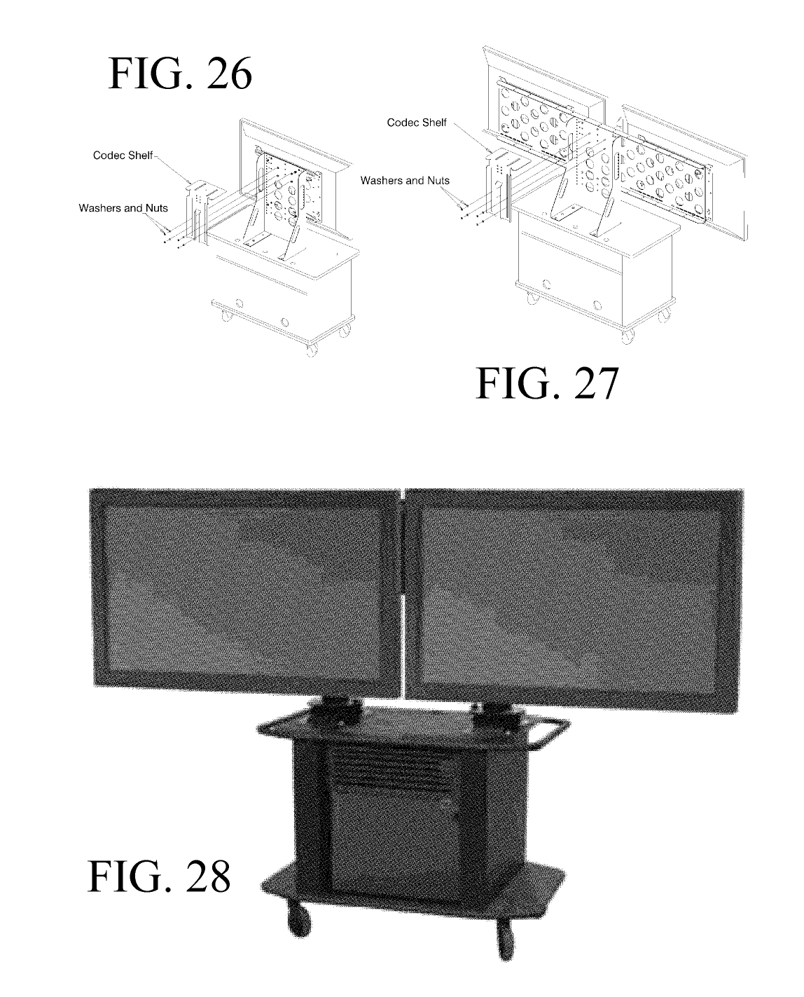

Also in these examples, a camera shelf may be installed around or between the monitors, as shown in FIGS. 14, 24 and 25, which provides a convenient location for a camera for videoconferencing. A camera or a codec could also be located to a codec shelf above one or both monitors, as shown in FIGS. 14, 26 and 27.

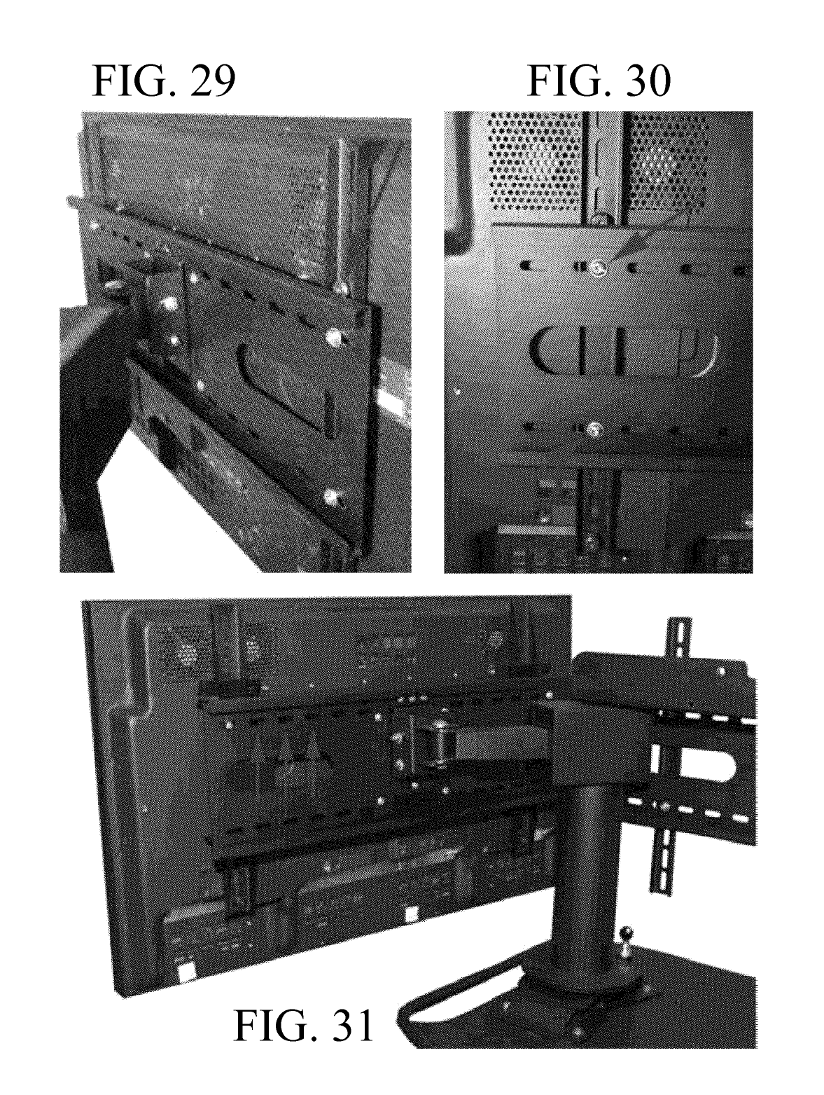

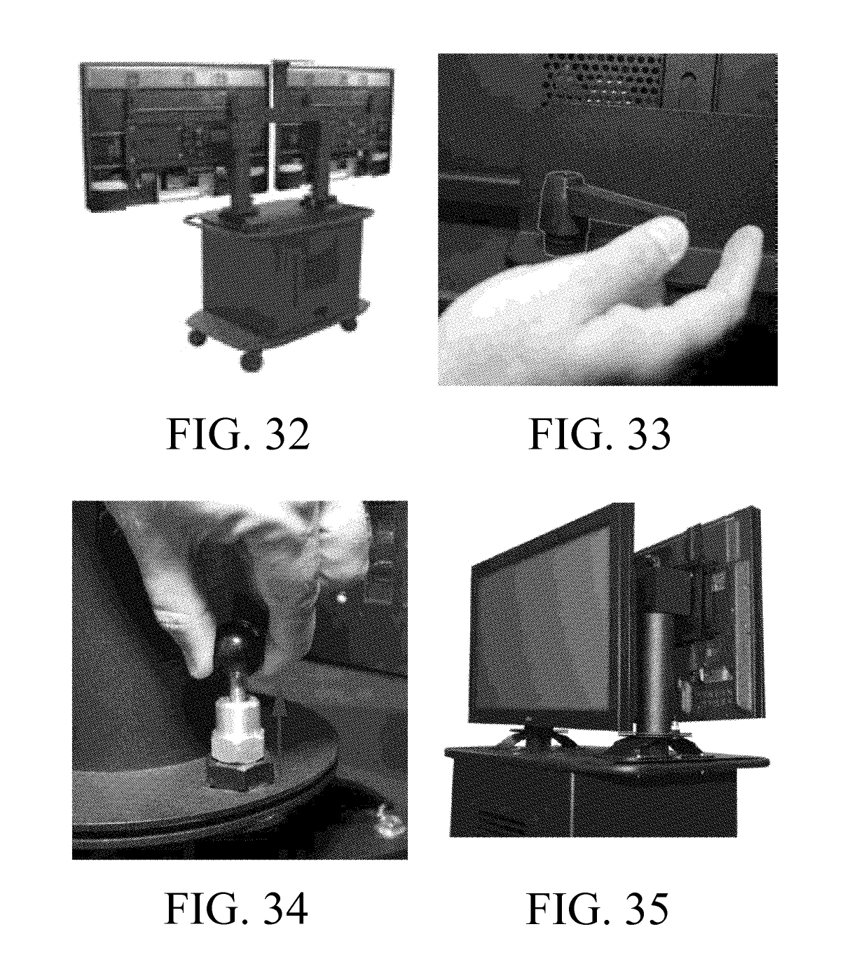

Now referring to FIG. 29, in a third exemplary fixture assembly a universal bracket is provided to mount a display to an articulating arm. Preferably a mounting bracket is provided that attaches directly to the display as shown in FIG. 30. The mounting bracket may then be attached to the universal bracket, preferably using an attachment method that provides ease of assembly. As shown in FIG. 31, the universal bracket preferably includes mountings for more than one size of display, allowing the end-user to select the display of his choice. The resulting fully-expanded fixture assembly may mount the displays side-by-side, as shown in FIGS. 28 and 32.

In this third example, a ratcheting lever is provided on the articulating arm, shown in FIG. 33, permitting the locking of the arm and its corresponding display in position on it's upward pivot. The locking of the lower pivot is by way of a pin and hole, released by pulling upward as shown in FIG. 34. Upon unlocking of the fixture assembly, it may be reconfigured from an expanded to a collapsed configuration, shown in FIG. 35, and vice-versa.

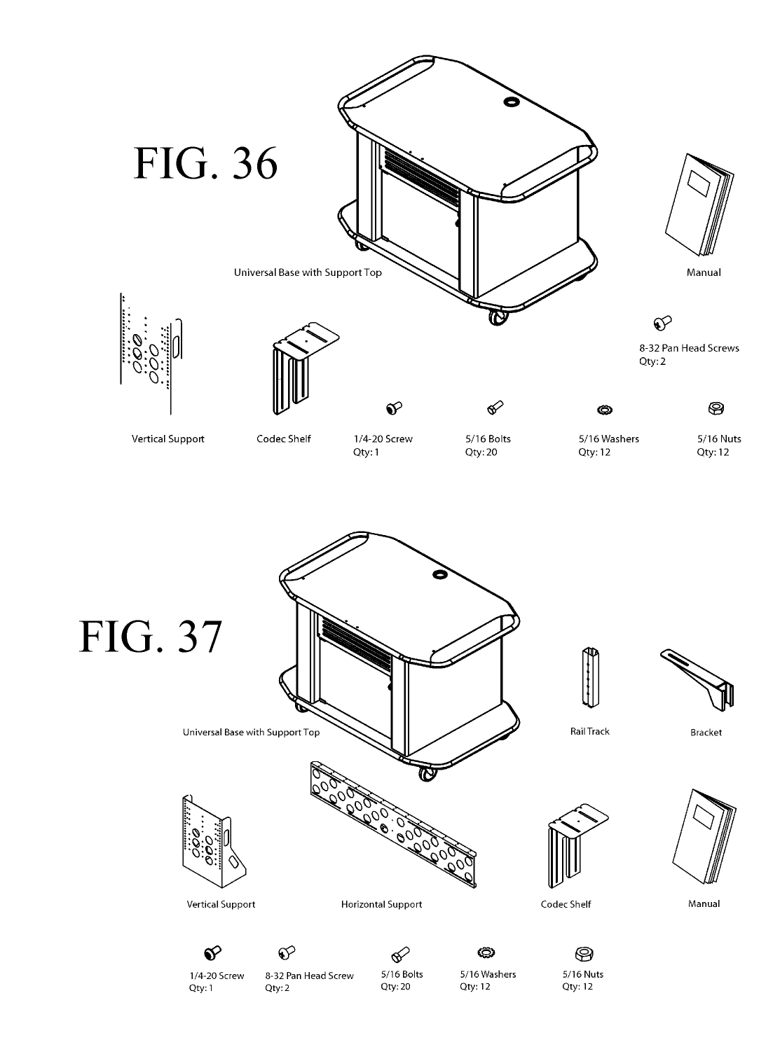

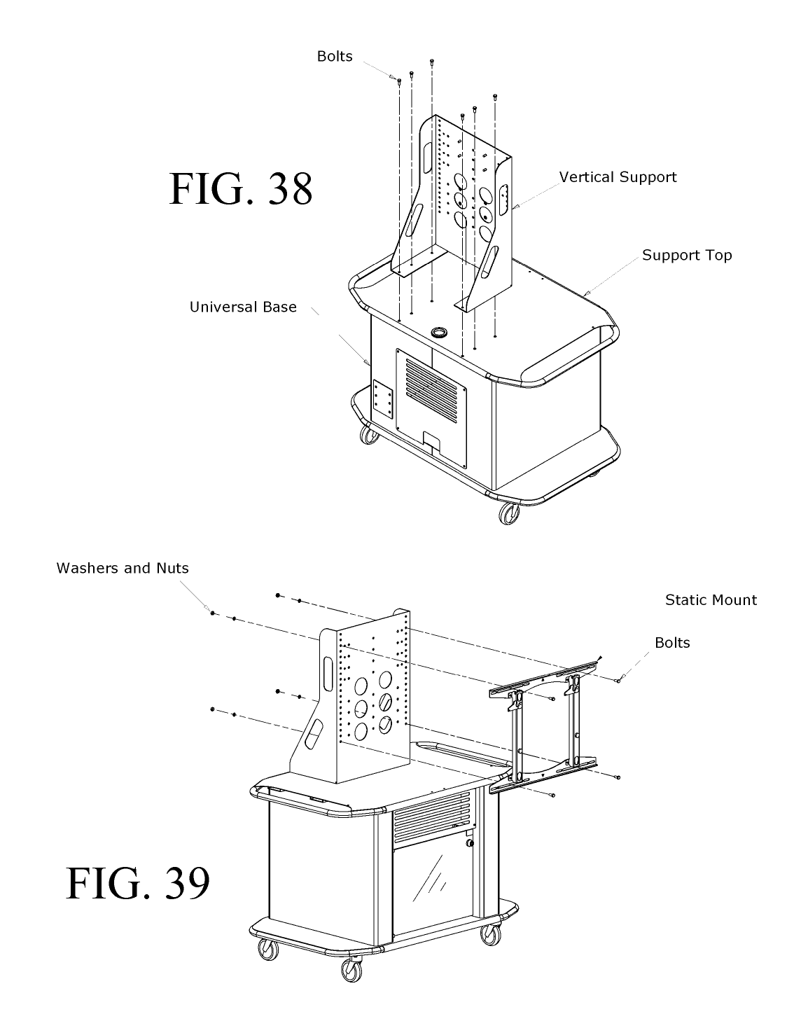

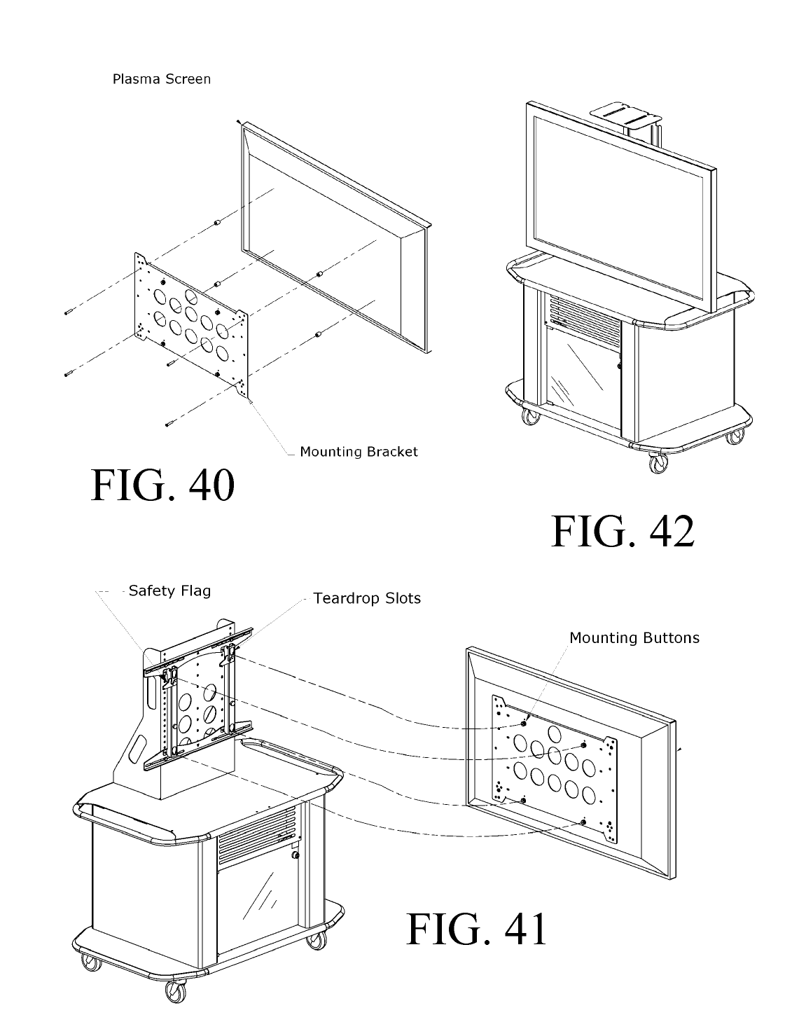

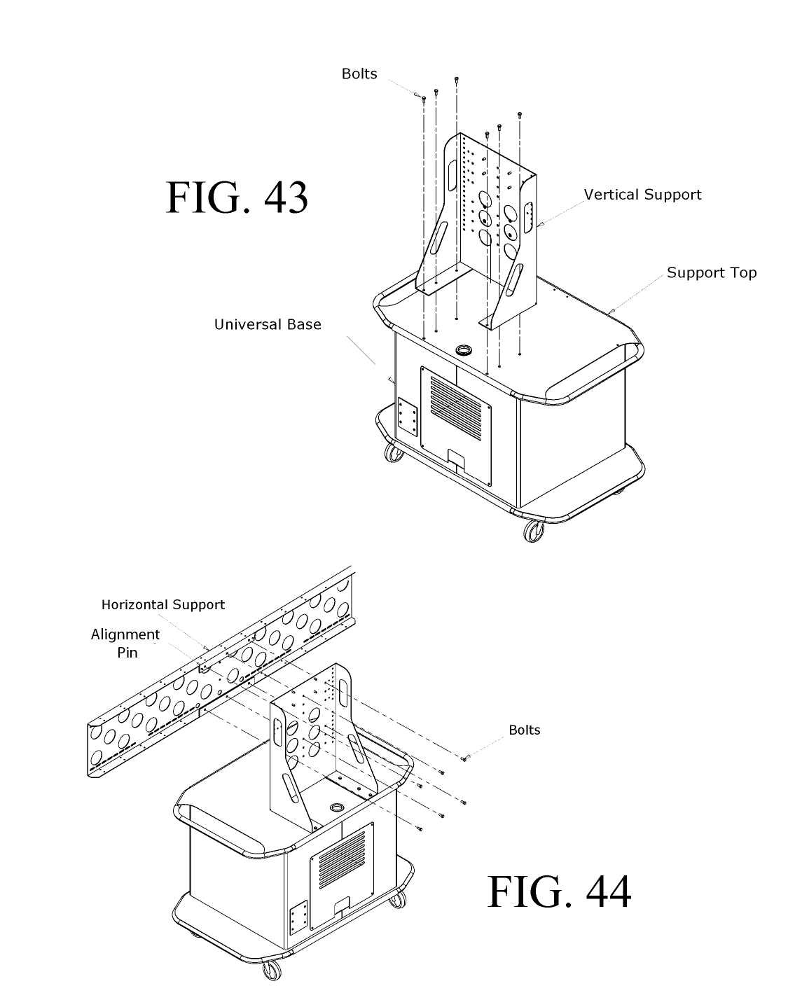

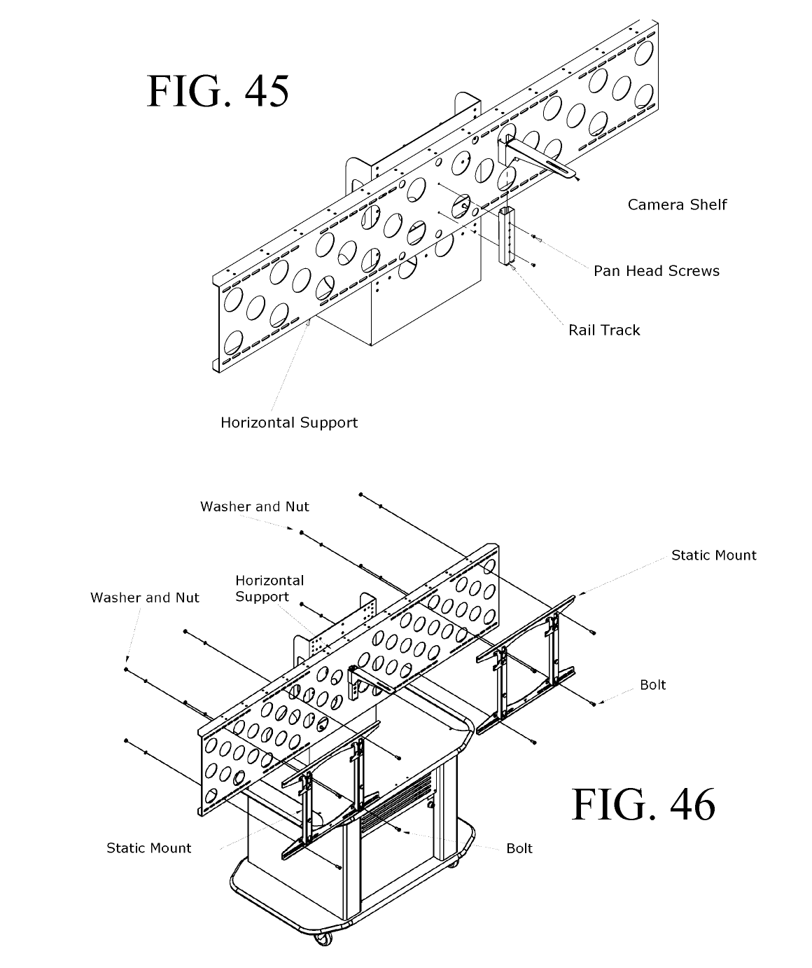

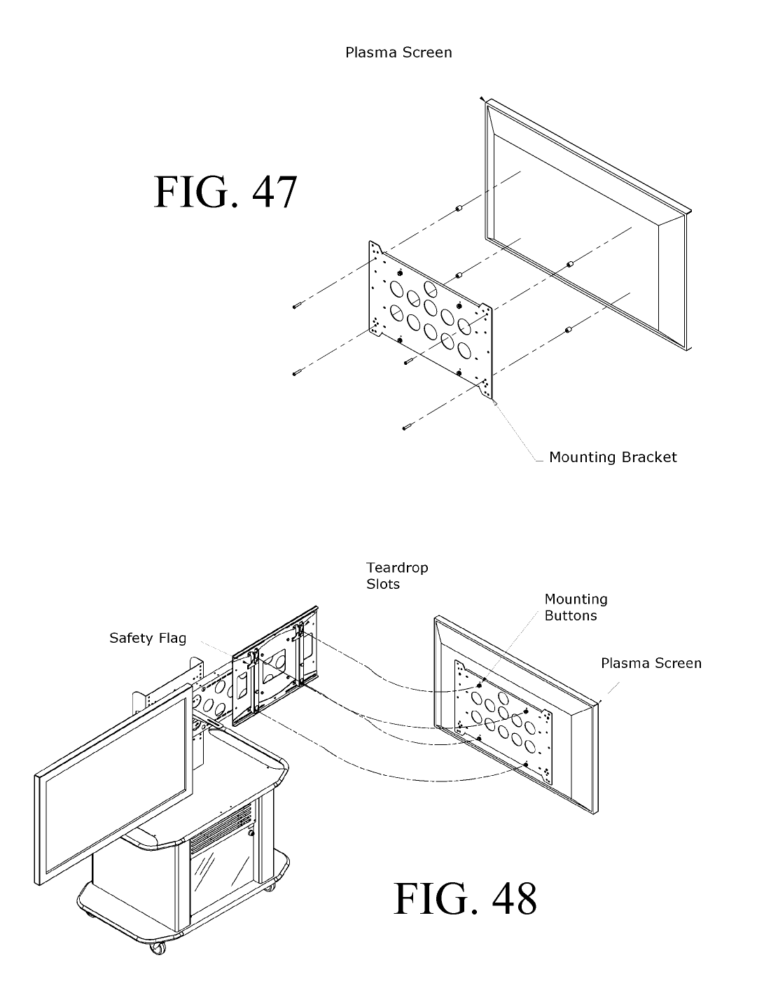

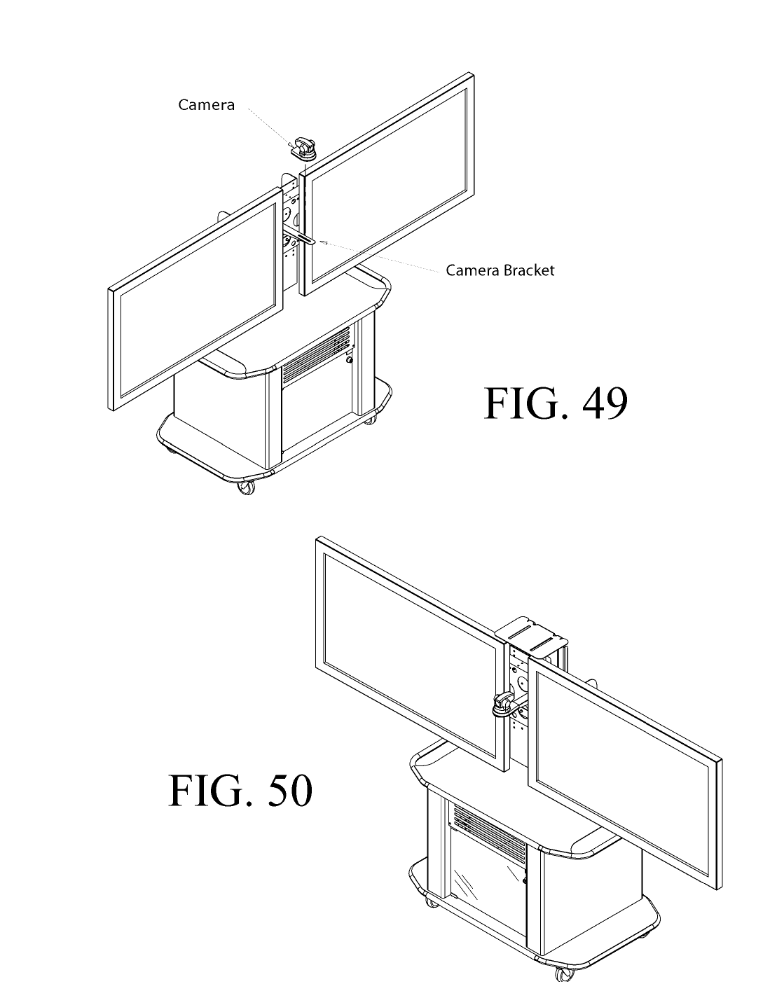

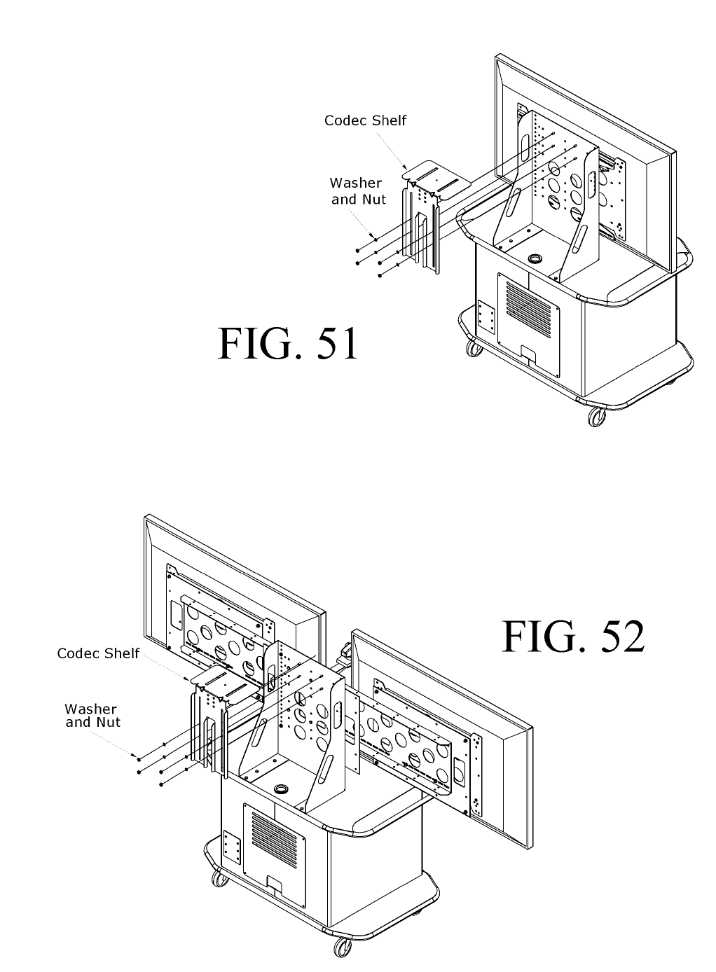

In a fourth example, a cart is provided having a top suitable for the static mounting of one or two displays, the parts for a one-display configuration shown in FIG. 36 and for a two-display configuration in FIG. 37. Assembly of the one-display configuration is by attachment of a vertical support as in FIG. 38, a static mount as in FIG. 39, a mounting bracket to the rear of the display as in FIG. 40, and hanging of the mounting bracket to the static mount by way of teardrop slots and buttons as shown in FIG. 41, resulting in the final product of FIG. 42. Assembly of the two-display configuration is by attachment of a vertical support as in FIG. 43, a horizontal support as in FIG. 44, optionally a camera shelf as in FIG. 45, two static mounts as in FIG. 46, a mounting bracket to the rear of each display as in FIG. 47, hanging of the mounting brackets to the static mounts by way of teardrop slots and buttons as shown in FIG. 48, and optionally attachment of a camera to the camera bracket as in FIG. 49, resulting in the final product of FIG. 50. A codec shelf may be attached as shown in FIG. 51 to the one-display configuration, or to the two-display configuration as shown in FIG. 52.

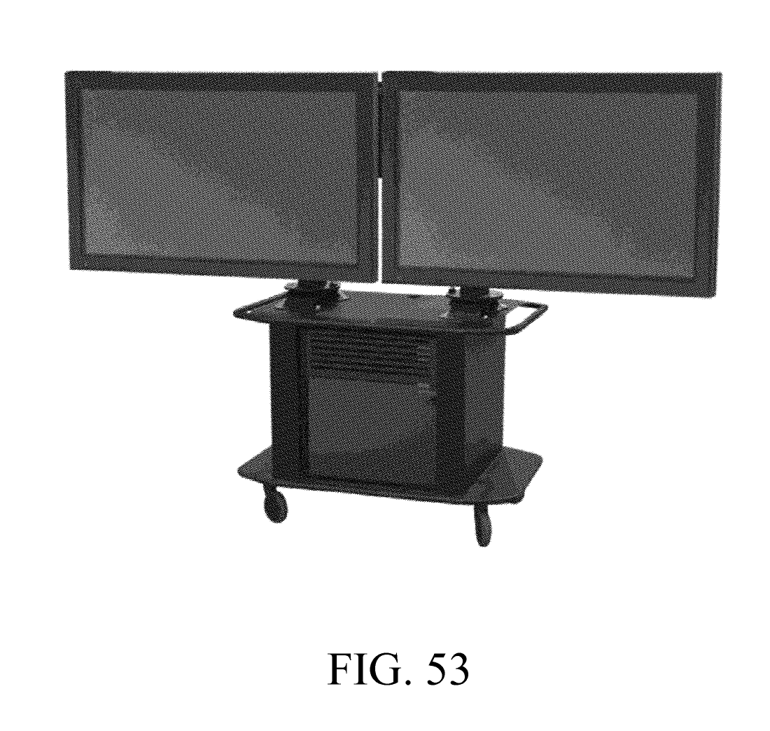

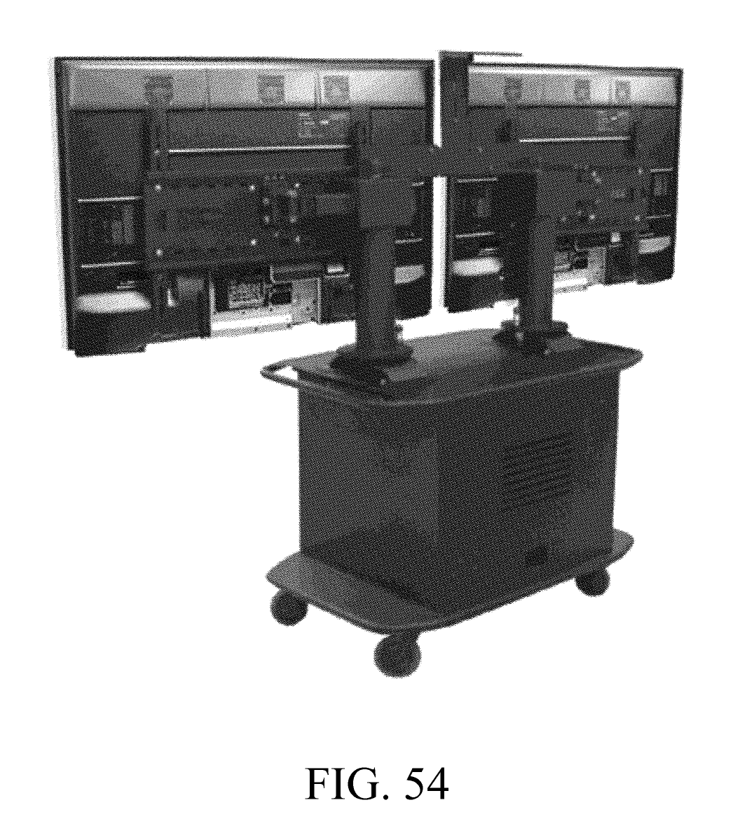

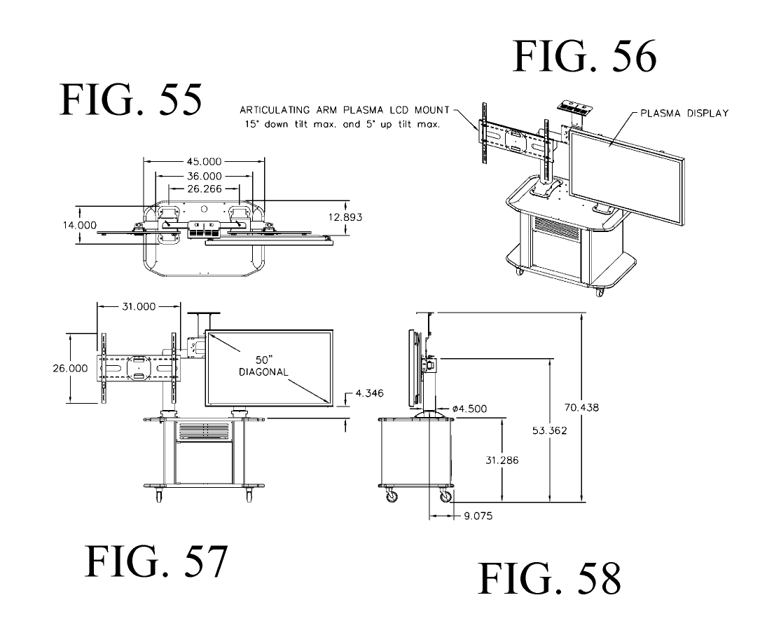

An articulating fixture arrangement can be attached to the base of the fourth example, as shown in FIG. 53 from the front, and FIG. 54 from the rear. This configuration is further detailed in FIGS. 55, 56, 57 and 58, the measurements being in inches. The examples above are configured to mount an ordinary 42 or 50 inch plasma or LCD display up to 200 lbs, and preferably the cart with displays and other included equipment weighs less than or equal to 800 lbs. In some versions a cart includes interior shelves and openings for the routing of cables from the interior to the displays above.

Now although certain systems, products, components, functions and methods have been described above in detail, one of ordinary skill in the art will recognize that these functions and methods are adaptable to other systems and products housing or mounting displays to a movable platform. The exact configurations described herein need not be adhered to, but may be varied according to the skill of one of ordinary skill in the art. Therefore, the inventions disclosed herein are to be fully embraced within the scope as defined in the claims. It is furthermore understood that the summary description and the abstract are provided merely for indexing and searching purposes, and do not limit the inventions presented herein in any way.

What is claimed:

1. A mobile display cart for mounting two displays in one configuration for viewing and another for moving between rooms, said cart comprising:
a relocatable platform, said platform being of a size and shape capable of relocation between two locations on a floor through manual effort, said platform having a front side;
a mounting frame within said platform, said frame capable of the attachment of objects;
two moving fixtures affixed to said mounting frame, each of said fixtures having a display mount whereby attachment of a flat display is provided for, said fixtures further each having a mobile element whereby its display mount and any attached flat display may be moved between a first and a second position;
wherein each of said fixtures is configured to position an attached display in said first position such that any attached display is viewable in the direction of said front side of said platform;
wherein each of said fixtures is configured to position an attached display in said second position, such that the display mount is located closer to the center of gravity of said relocatable platform.

2. A mobile display cart according to claim 1, wherein each of said fixtures is configured to position an attached display in a second position, such that the attached display is located above said mounting frame.

3. A mobile display cart according to claim 1, wherein one of said fixtures is configured to position an attached display in a second position, such that the attached display faces the opposite direction as the front side.

4. A mobile display cart according to claim 1, wherein the two fixtures are configured to position attached displays back-to-back when each fixture is in said second position.

5. A mobile display cart according to claim 1, wherein said mounting frame is a horizontal tabletop incorporated to said platform.

6. A mobile display cart according to claim 1, wherein said display mount includes a mounting arm, and further wherein said mobile elements are a pivot point providing for the rotation of said mounting arm around a pivot, the rotation providing for the movement of a display attached to said display mount between a first and second position.

7. A mobile display cart according to claim 1, wherein each of said fixtures provide for a range directions when said fixtures are in said first position.

8. A mobile display cart according to claim 1, wherein each of said fixtures includes a post on which each display mount may be independently rotated.

9. A mobile display cart according to claim 1, wherein said fixtures share a common post.

10. A mobile display cart according to claim 1, wherein a display is mounted to each display mount.

11. An articulating fixture for a mobile display cart that mounts two displays in one configuration for viewing and another for moving between rooms, said fixture comprising:
a pair of articulating arms each having two ends, each end including a pivot;
for each arm, a display mount each attached to a first pivot said arm whereby said mount may be rotated in direction with respect to the arm to which it is attached;
for each arm, an attachment for a post through a second pivot whereby said arm may be rotated in direction with respect to an attached post;
wherein each arm is attached to a post through its second pivot, and
wherein each articulating arm is mounted by its post to a mounting frame.

12. An articulating fixture according to claim 11, wherein each of said articulating arms is configured to position an attached display in a position such that the attached display is located above said mounting frame.

13. An articulating fixture according to claim 11, wherein one of said articulating arms is configured to position an attached display such that the attached display faces the opposite direction as the display of the other of said fixtures.

14. An articulating fixture according to claim 11, wherein the two articulating arms are configured to position attached displays back-to-back.

15. An articulating fixture according to claim 11, wherein said mounting frame is a horizontal tabletop.

16. An articulating fixture according to claim 11, wherein each of said articulating arms provide allow for the two displays to be faced in the same direction for a range of directions.

17. An articulating fixture according to claim 11, wherein each of said articulating arms are mounted to a separate post on which each display mount may be independently rotated.

18. An articulating fixture according to claim 11, wherein said articulating arms are attached to a common post.

19. An articulating fixture according to claim 11, wherein a display is mounted to each display mount.
